(19) United States
(12) Patent Application Publication
(10) Pub. No.: US 2004/0165566 A1
(43) Pub. Date: Aug. 26, 2004

(54) Dual mode modem and method for integrated cell searching

(76) Inventors: Dong-Hoon Lee, Seoul (KR); Sung-Jae Kim, Suwon-city (KR); Dong-Ryeol Ryu, Seoul (KR)

Correspondence Address: HARNESS, DICKEY & PIERCE, P.L.C., P.O. BOX 8910, RESTON, VA, 20195, US

(21) Appl. No.: 10/762,519

(22) Filed: Jan. 23, 2004

(30) Foreign Application Priority Data
Feb. 22, 2003 (KR) 2003-11207

(51) Int. Cl. H04B 7/216

(52) U.S. Cl. 370/342; 370/350

(57) ABSTRACT

An integrated cell searcher of a dual mode modem, which supports different communication modes, is provided.

### BACKGROUND OF THE INVENTION

This application claims the priority of Korean Patent Application No. 2003-11207, filed on Feb. 22, 2003, in the Korean Intellectual Property Office, the disclosure of which is incorporated herein in its entirety by reference.

1. Field of the Invention

The example embodiments of the present invention relate to digital mobile communication, and more particularly, to an integrated cell searcher of a dual mode modem capable of supporting two different communication modes.

2. Description of the Related Art

With the imminent commercialization of third-generation (3G) mobile communication, the domestic mobile communication industry faces demands for modems capable of supporting a variety of communication modes. A Dual mode modem handles two (or, in other words, dual) modes.

A cell searcher is part of a single-mode 3G modem. A dual mode modem requires different and independent cell searchers for different communication modes that it provides.

FIG. 1 is a block diagram of a related third-step cell searcher of a universal mobile telecommunications system (UMTS). In UMTS, cell searchers are classified into a first-step cell searcher, a second-step cell searcher, and a third-step cell searcher. The first-step and second-step cell searchers are introduced to determine how to match a group of pseudonoise (PN) codes with a PN code of a base station. Thereafter, the third-step cell searcher 100 searches for an exact PN code corresponding to the PN code of the base station.

In FIG. 1, a third-step cell searcher 100 includes a UMTS code generator 11, an input controller 12, a plurality of correlators 131, . . . , 138, 149, . . . , 156, a receptor 15 that receives a signal Rx from a base station, and a peak detector 16 that receives correlation results and outputs a signal OUT indicative of which PN code correlated best. In FIG. 1, 8 correlators constitute one correlator bank. More specifically, the correlators 131 through 138 constitute a first correlator bank 13, and the correlators 149 through 156 constitute a second correlator bank 14.

The UMTS code generator 11 generates 16 codes that belong to a code group determined by a second-step cell searcher (not shown). The input controller 12 receives the codes from the UMTS code generator 11 and outputs the codes to the correlators 131 through 138 and 149 through 156.

The receptor 15 receives a signal (Rx) from a base station (not shown) and outputs the signal Rx to the correlators 131 through 138 and 149 through 156. Accordingly, the correlators 131 through 138 and 149 through 156 receive the signal Rx from the receptor 15 in parallel.

The correlators 131 through 138 and 149 through 156 receive and correlate the PN codes output from the input controller 12 and the signal Rx output from the receptor 15 and output correlation results to the peak detector 16. The peak detector 16 detects which of the PN codes is most highly correlated to the PN code received from the base station based upon the correlation results. Thereafter, the peak detector 16 outputs the detected PN code OUT.

The peak detector 16 detects the PN code most highly correlated to the received PN code among signals output from the 8 correlators of each of the correlator banks 13 and 14 or among signals output from the 16 correlators of the correlator banks 13 and 14. Accordingly, is possible to perform a cell searching process on a 16-code basis.

FIG. 2 is a block diagram of a multi-path searcher of a UMTS. A multi-path searcher 200, like the third-step cell searcher 100 of FIG. 1, FIG. 2 includes a UMTS code generator 11, an input controller 12, a plurality of correlators 231, 232, 241, 242, a receptor 15 that receives a signal Rx from a base station, and a peak detector 16 that receives correlation results and outputs a signal OUT indicative of which PN code correlated best.

The multi-path searcher 200 is different from the third-step cell searcher 100 of FIG. 1 as follows. A terminal (UE) (not shown) sometimes obtains information on neighboring cells adjacent to the cell in which it currently belongs. The neighboring cell information includes scrambling code numbers of the neighboring cells, time difference information between the cell in which the terminal (UE) currently belongs and the neighboring cells, and information whether or not the neighboring cells employ reception and transmission multiplexing. In the multi-path searcher 200 of FIG. 2, it is assumed that neighboring cell information is provided, that the neighboring cell information includes scrambling code numbers of neighboring cells and that time difference information between a current cell and each of the neighboring cells is available. One difference between the third-step cell searcher 100 of FIG. 1 and the multi-path searcher 200 of FIG. 2 is that the multi-path searcher 200 has some knowledge of a PN code of a base station and sequentially carries out a window-based search on active set cells and cells that are determined to have handover functions through neighboring cell search.

In FIG. 2, the correlator A1 (231) and the correlator A2 (232) are an on-time correlator and a late correlator, respectively. The two correlators A1 and A2 (231 and 232) are capable of performing cell searches at a resolution two times higher than a chip rate and can work together to calculate correlation values. Therefore, the two correlators A1 and A2 (231 and 232) search for cells in synchronization with a clock signal 8 times faster than the operation clock signal of a chip.

FIG. 3 is a block diagram of a cell searcher of a code division multiple access (CDMA 2000) system. As shown in FIG. 3, a cell searcher 300 of a CDMA 2000 system includes a CDMA 2000 code generator 31, an input controller 35, a receptor 35 which receives a signal Rx from a base station, a plurality of correlators 331, 332, 341, and 342, and a peak detector 36 which receives correlation results and outputs signal OUT indicative of which PN code correlated best.

In FIG. 3, two pairs of correlators (331, 332) and (341, 342) constitute a set of on-time correlators and late correlators, respectively. The operation of the cell searcher 300 is similar to the operation of the multi-path searcher 200 of FIG. 2. In other words, the cell searcher 300 of FIG. 3 may have the same structure as the multi-path searcher 200 of FIG. 2 except for the structure of the correlators (331, 332) and (341, 342). In addition, the method by which the cell searcher 300 correlates may be similar to the way the multi-path searcher 200 of FIG. 2 correlates.

In other words, related cell searchers for modems using different communication modes, like those shown in FIGS. 1 through 3, are similar to one another in terms of either their structure or operation.

### SUMMARY OF EXAMPLE EMBODIMENTS OF THE INVENTION

At least one example embodiment of the present invention provides an integrated cell searcher of a dual mode modem that supports different communication modes.

One example embodiment provides a method of operation that can be implemented by an integrated cell searcher of a dual mode modem that supports different communication modes.

### BRIEF DESCRIPTION OF THE DRAWINGS

The above and other features and advantages of the embodiments of the present invention will become more apparent by describing in detail example embodiments thereof with reference to the attached drawings in which:

FIG. 1 is a block diagram of a third-step cell searcher of a universal mobile telecommunications system (UMTS) according to the Related Art;

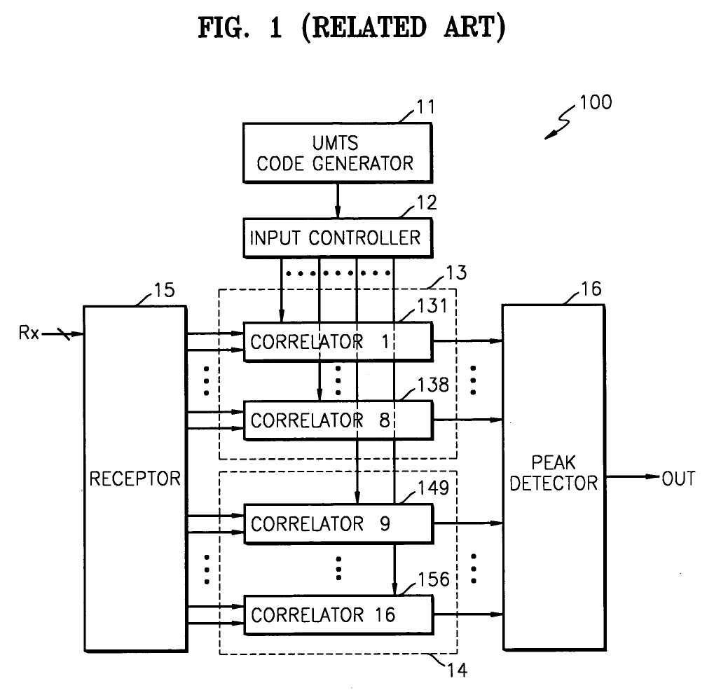

FIG. 2 is a block diagram of a multi-path searcher of a UMTS according to the Related Art;

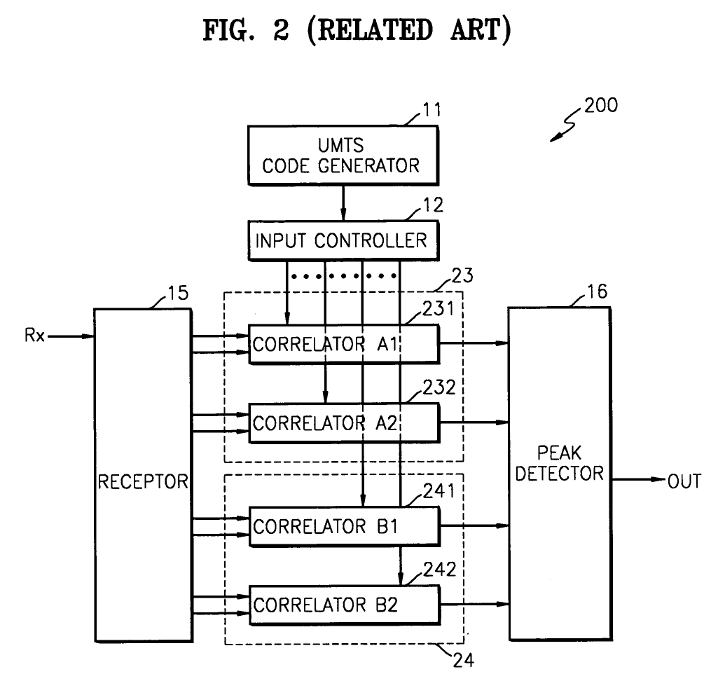

FIG. 3 is a block diagram of a cell searcher of a code division multiplex access (CDMA) 2000 system according to the Related Art;

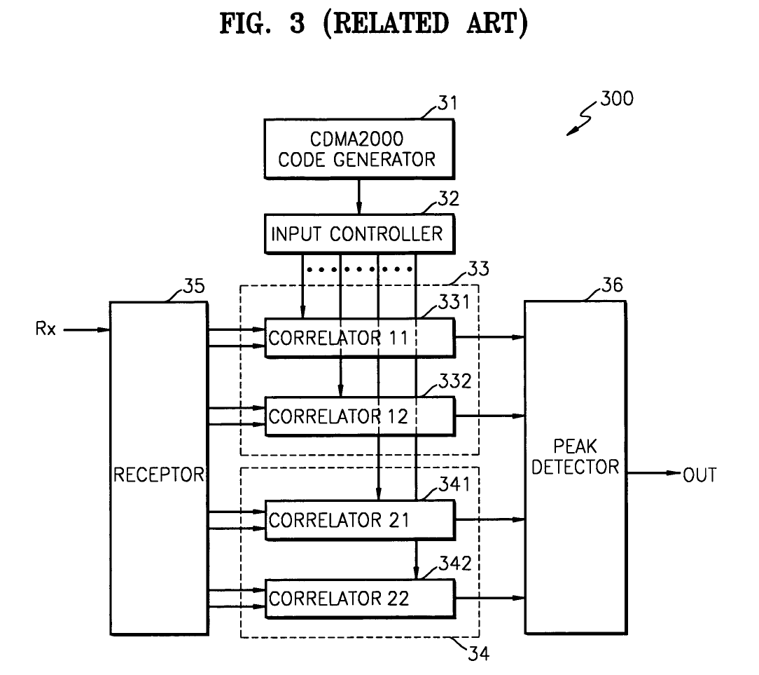

FIG. 4 is a block diagram of an integrated cell searcher according to a first example embodiment of the present invention;

FIG. 5 is a block diagram of an integrated cell searcher according to a second example embodiment of the present invention;

FIG. 6 is a detailed block diagram of a pseudonoise (PN) signal selector shown in FIG. 5 according to an embodiment of the present invention;

FIG. 7 is a detailed block diagram of a correlator shown in FIG. 5;

FIG. 8 is a block diagram of an integrated cell searcher according to a third example embodiment of the present invention;

FIG. 9 is a detailed block diagram of a correlator shown in FIG. 8; and

FIG. 10 is a block diagram of an integrated cell searcher according to a fourth example embodiment of the present invention.

### DETAILED DESCRIPTION OF EXAMPLE EMBODIMENTS OF THE INVENTION

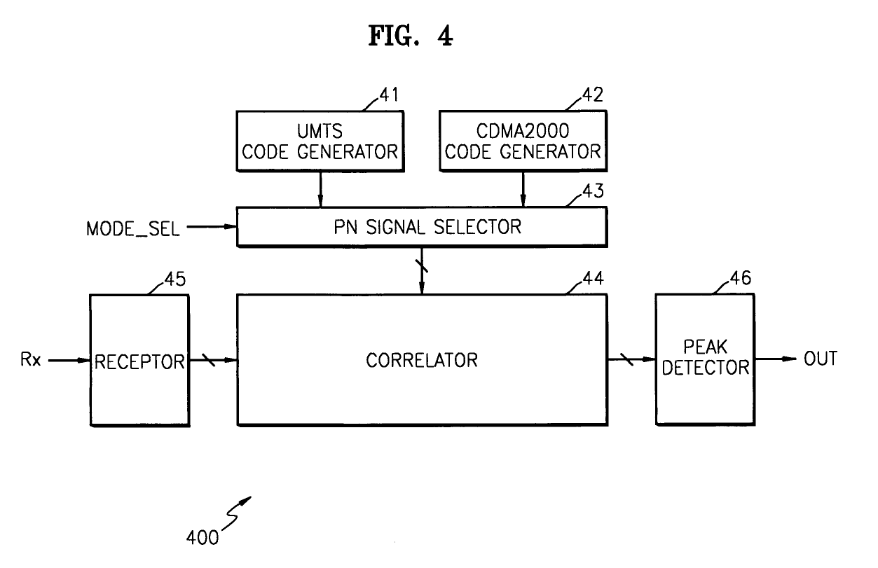

The example embodiments of the present invention will be described more fully with reference to FIGS. 4-10 The same reference numerals in different drawings represent the same elements.

In developing the present invention, the following problem with the Related Art was recognized and the path to a solution thereof determined. A dual mode modem according to the Related Art requires a cell searcher circuit for each of its two modes. Such separate circuits frustrate efforts to reduce the size of a dual mode modem, plus add complexity, increase cost, etc. Study of the Related Art cell searcher circuits revealed a degree of similarity in components sufficient such that a combined/integrated (or in other words, dual mode) cell searcher circuit could achieve a significant economy of components. Embodiments of the present invention provide such a combined/integrated dual-mode cell searcher circuit (“searcher circuit” hereafter being referred to as a “searcher”).

FIG. 4 is a block diagram of an integrated cell searcher according to a first example embodiment of the present invention. Referring to FIG. 4, a cell searcher 400 may include a universal mobile telecommunications system (UMTS) code generator 41, a code division multiple access CDMA 2000 code generator 42, a pseudonoise (PN) signal selector 43 which receives a MODE_SEL signal, a correlator 44, a receptor 45 which receives an input signal RX from a base station, a peak detector 46 which receives correlation results and outputs a signal OUT indicative of which PN code best correlated to signal RX.

The UMTS code generator 41 and the CDMA 2000 code generator 42 may generate codes used for cell searching in a universal mobile telecommunications system (UMTS) mode and a CDMA 2000 mode, respectively. Cell searching which is a process of calculating the degree to which the corresponding codes (from generators 41 and 42) and codes received from base stations are correlated.

The PN signal selector 43 may receive the codes generated by the UMTS code generator 41 and the CDMA 2000 code generator 42 and outputs one of the generated codes to the correlator 44. A mode selection signal MODE_SEL input to the PN signal selector 43 may be used to determine which among the codes output from the UMTS code generator 41 or the code output from the CDMA 2000 code generator 42 will be output to the correlator 44.

More specifically, when the mode selection signal MODE_SEL is in a first logic state, for example, a logic high state, the PN signal selector 43 may output the code generated by the UMTS code generator 41 to the correlator 44. On the other hand, when the mode selection signal MODE_SEL is in a second logic state, for example, a logic low state, the PN signal selector 43 may output the codes generated by the CDMA 2000 code generator 42 to the correlator 44.

The receptor 45 receives a code Rx from a base station and outputs the received code Rx to the correlator 44. The correlator 44 correlates the code Rx and the selected codes from the PN signal selector 43, and outputs correlation result. Peak Detector 46 receives the correlation results and identifies (via output signal OUT) which among the selected PN codes yielded the best correlation results.

According to an example embodiment of the present invention, it is possible to selectively carry out cell searching in non-synchronous mode (UMTS mode) or synchronous mode (CDMA 2000 mode) in response to the mode selection signal MODE_SEL.

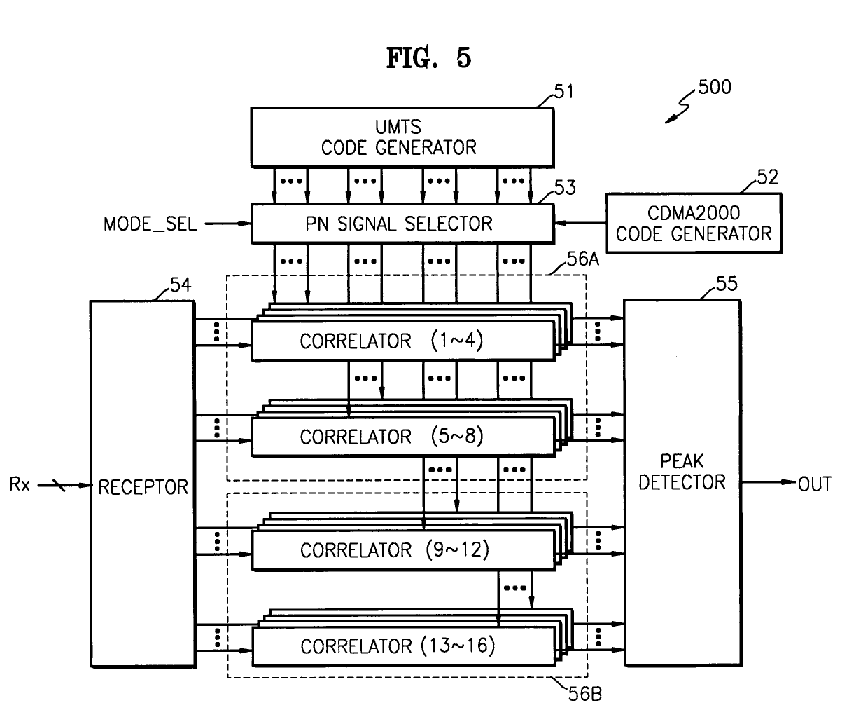

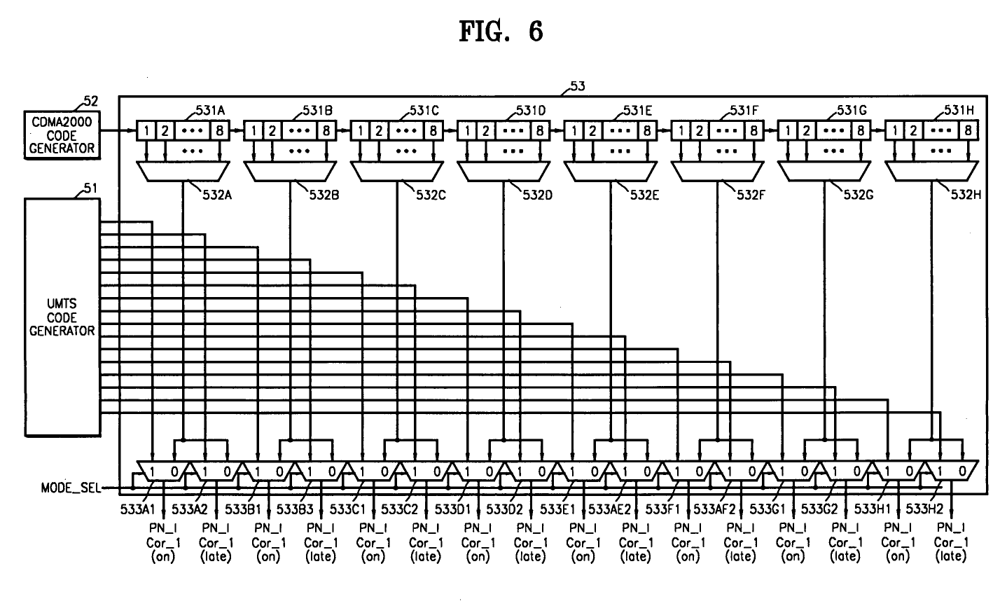

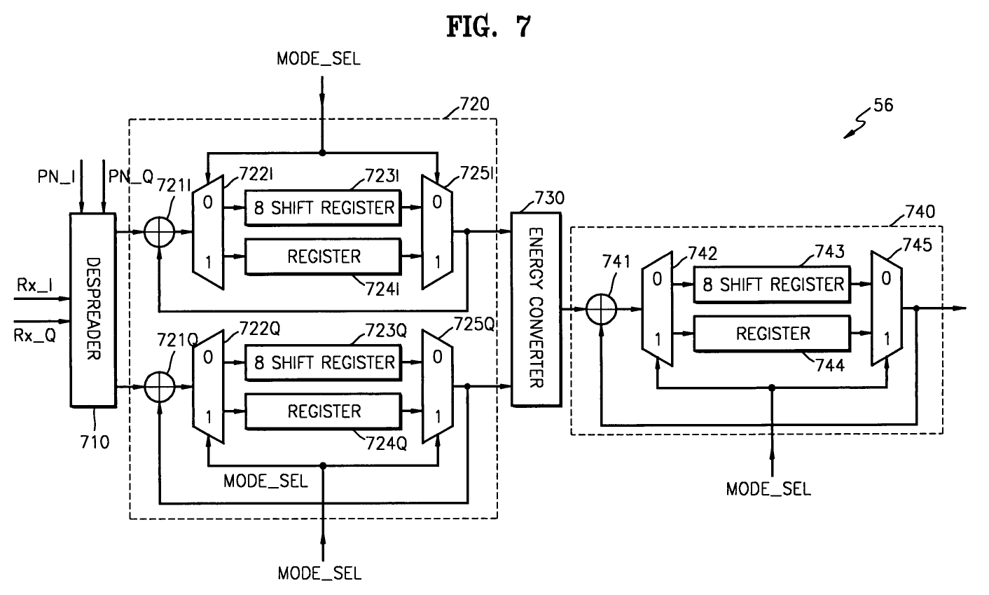

FIG. 5 is a block diagram of an integrated cell searcher 500 according to a second example embodiment of the present invention, FIG. 6 is a detailed block diagram of a PN signal selector 53 shown in FIG. 5, and FIG. 7 is a detailed block diagram of a correlator 56 (56A, 56B) shown in FIG.

5. Referring to FIG. 5, cell searcher 500 has a UMTS mode and is capable of carrying out cell searching in a CDMA 2000 mode at a 64× speed.

The cell searcher 500 of FIG. 5 may include a UMTS code generator 51, a CDMA 2000 code generator 52, a PN signal selector 53, a receptor 54, a peak detector 55, and a plurality of correlators 56A and 56B. The PN signal selector 53 of FIG. 6 may include a plurality of 8-bit shift registers 531A through 531H connected in series, a plurality of multiplexers (MUXs) 532A through 532H, and a plurality of selectors 533A1, 533A2, 533B1, 533B2, 533C1, 533C2, 533D1, 533D2, 533E1, 533E2, 533F1, 533F2, 533G1, 533G2, 533H1, and 533H2. Example connections among the elements of the PN signal selector 53 are illustrated in FIG. 6. The correlator 56 of FIG. 7 may include a despreader 710, a synchronization accumulation register 720, an energy converter 730, and a non-synchronization accumulation register 740.

Referring to FIG. 5, the PN signal selector 53 receives codes from the UMTS code generator 51 a set of codes from the CDMA 2000 code generator 52 and selectively outputs one of the received sets of codes in response to the mode selection signal MODE_SEL.

As shown in FIG. 6, a set of codes generated by the CDMA 2000 code generator 52 may be sequentially input into 8-bit registers 531A through 531H, and the codes registered in each of the 8-bit registers 531A through 531H may be output to 16 selectors 531 A1, 531A2, . . . , 533H2 via multiplexers 532A through 532H. The MUXs 532A through 532H may operate in synchronization with a clock signal 8 times faster than the nominal clock signal for the dual mode modem. In other words, the MUXs 532A through 532H may output the code registered in each of the registers 531A through 531H at 8× speed.

Still referring to FIG. 6, the codes generated by the UMTS code generator 51 may be output to the 16 selectors 531 A1, 533A2, . . . , 533H2. Thereafter, the selectors 533A1, 533A2, . . . , 533H2 may selectively output the codes output from the UMTS code generator 51 or the codes received (via MUXs 532A-532H) from the CDMA 2000 code generator 52 in response to the mode selection signal MODE_SEL.

In the correlator 56 of FIG. 7, a despreader 710 may despread codes Rx_I and Rx_Q, received from a base station, and signals PN_I and PN_Q, output from the PN signal selector 53. A synchronization accumulative register 720 may include an adder 721I, a selector 722I connected to the adder 721I, an 8-bit shift register 723I connected to the selector 722I, a register 724I connected to the selector 722I, and another selector 725I connected to the output ports of the 8-bit shift register 723I and the register 724I and may have an output port connected to the input port of the adder 721I. The despreader 710 may further include an adder 721Q, a selector 722Q, an 8-bit shift register 723Q, a register 724Q, and another selector 725Q, which may be the same as their counterparts 721I, 722I, 723I, 724I, and 725I. The elements 721I through 725I may be provided for in-phase (I) components, and the elements 721Q through 725Q may be provided for quadrature-phase (Q) components.

Each of the selectors 722I, 725I, 722Q and 725Q may be controlled by the mode selection signal MODE_SEL. For example, when the mode selection signal MODE_SEL is in a first logic state, for example, a logic high state, the synchronization accumulative register 720 may operate in a UMTS mode and an accumulation result may be stored in the registers 724I and 724Q. When the mode selection signal MODE_SEL is in a second logic state, for example, a logic low state, the synchronization accumulative register 720 may operate in a CDMA 2000 mode and the accumulation result may be stored in the 8-bit shift registers 723I and 723Q.

The synchronization accumulative register 720 may, optionally, operate in synchronization with a clock signal, which is not specifically illustrated in FIG. 7.

Still referring to FIG. 7, an energy converter 730 receives I and Q components from the synchronization accumulative register 720 and converts the received I and Q components into energy signals. An asynchronization accumulative register 740 may include an adder 741, selectors 742 and 745, an 8-bit shift register 743, and a register 744. The asynchronization accumulative register 740 may repeatedly perform a process, which might involve receiving signals from the energy converter 730, adding the received signals, and storing the resulting sum in the 8-bit shift register 743 or the register 744.

The integrated cell searcher 500 illustrated in FIGS. 5 through 7 can perform cell searching either in a UMTS mode or in a CDMA 2000 mode depending on the logic state of the mode selection signal MODE_SEL. The PN signal selector 53 and the correlator 56, implemented in the integrated cell searcher 500, may have the structures shown in FIGS. 6 and 7, respectively.

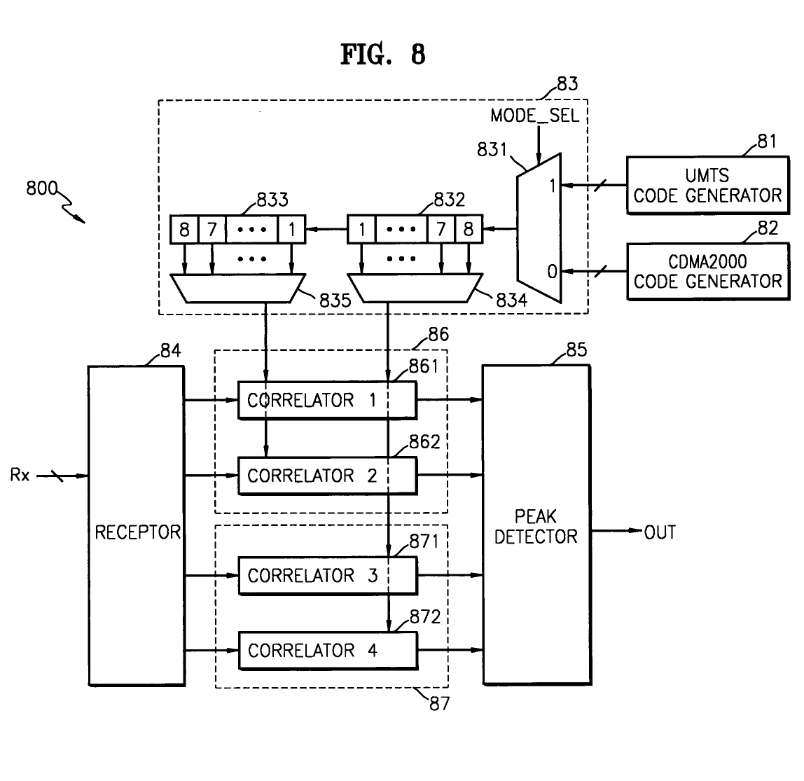

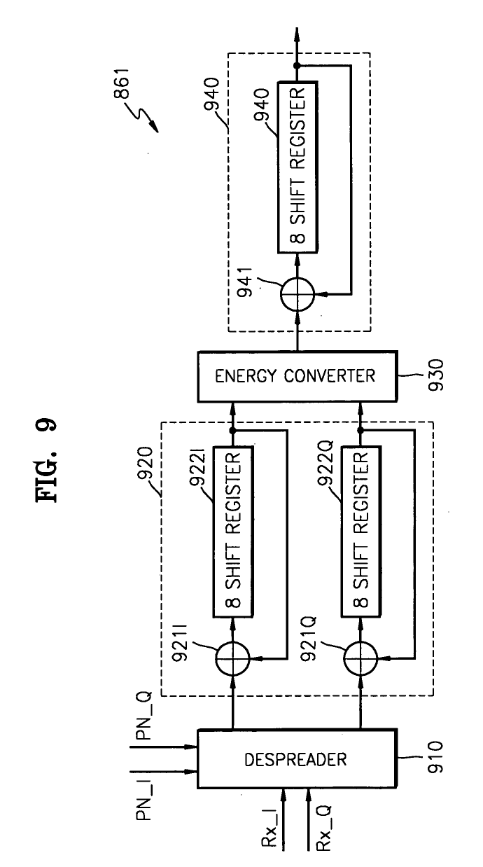

FIG. 8 is a block diagram of an integrated cell searcher according to a third example embodiment of the present invention, and FIG. 9 is a detailed block diagram of a correlator shown in FIG. 8. A cell searcher 800 shown in FIG. 8 may be configured to exhibit advantages of a UMTS multi-path cell searcher structure and may be capable of performing cell searching at 16× speed in a CDMA 2000 mode.

Referring to FIG. 8, the cell searcher 800 includes a UMTS code generator 81, a CDMA 2000 code generator 82, a PN signal selector 83, a receptor 84, a peak detector 85, and a plurality of correlators 861, 862, 871, and 872. The first correlator unit 86 may include the correlators 871 and 872, which carry out cell searching at 8× speed. A second correlator unit 87 may include the correlators 871 and 872, which carry out cell searching at 8× speed.

The PN signal selector 83 may include a selector 831, 8-bit shift registers 832 and 833, and multiplexers 834 and 835. The selector 831 selectively outputs either an output signal of the UMTS code generator 81 or an output signal of the CDMA 2000 code generator 82 in response to a mode selection signal MODE_SEL.

The shift registers 832 and 833 may be connected in series and store an output signal of the selector 831. The multiplexer 834 may receive 8 codes stored in the shift register 832 in parallel and may output the received codes in series in synchronization with a clock signal. The multiplexer 835 may receive 8 codes stored in the shift register 833 in parallel and may output the received codes in series in synchronization with the clock signal. Because of the 8-bit shift registers 832 and 833, the clock signal may be 8 times faster than the operation clock of a chip.

Again, the structure of a UMTS multi-path searcher may be similar to the structure of a CDMA 2000 searcher. Therefore, in order to integrate the UMTS multi-path searcher and the CDMA 2000 searcher into one device, the correlators 861, 862, 871, and 872 may be shared by the UMTS multi-path searcher and the CDMA 2000 searcher, and an integrated cell searcher constituted by the UMTS multi-path searcher and the CDMA 2000 searcher may be able to selectively operate in a UMTS mode or a CDMA 2000 mode.

An example of the correlator 861 of FIG. 8 is illustrated in FIG. 9. Referring to FIG. 9, the correlator 861 may include a despreader 910, a synchronization accumulative register 920, an energy converter 930, and a non-synchronization accumulative register 940. The elements of the correlators 861 may be similar to their counterparts of the correlator 56 of FIG. 7 that have been described above. An example of a difference between the correlator 861 and the correlator 56 of FIG. 7 is that the synchronization accumulative register 920 and the non-synchronization accumulative register 940 of correlator 861 share an 8-bit shift register 922I rather than having separate registers and associated selectors to accommodate the different modes, e.g., a UMTS mode and a CDMA 2000 mode.

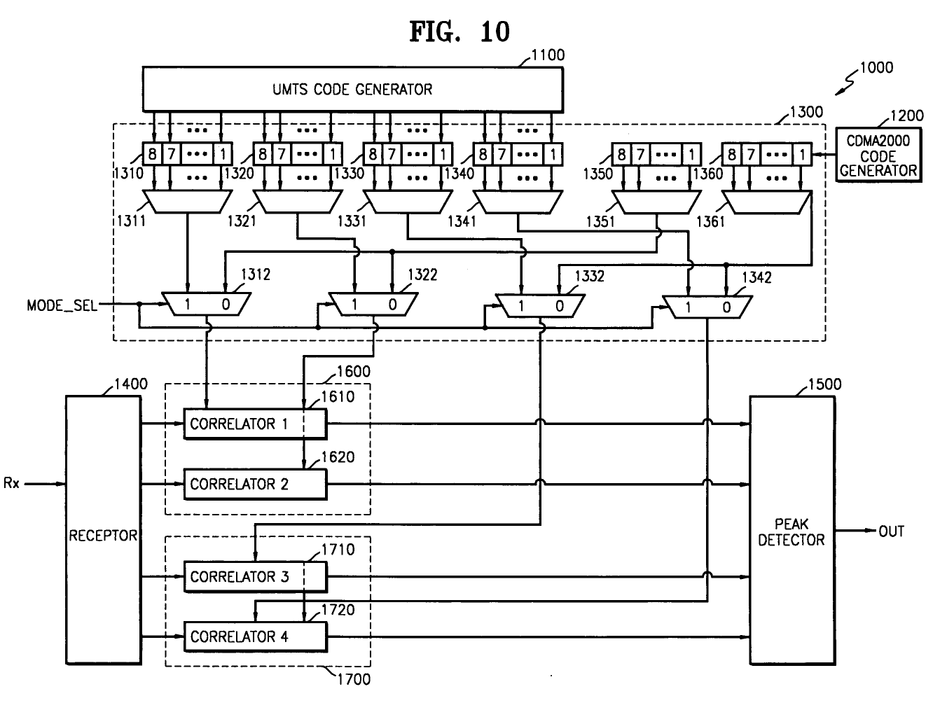

FIG. 10 is a block diagram of an integrated cell searcher according to a fourth example embodiment of the present invention. Referring to FIG. 10, a cell searcher 1000 may include a UMTS code generator 1100, a CDMA 2000 code generator 1200, a PN signal selector 1300, a receptor 1400, a peak detector 1500, and a plurality of correlators 1610, 1620, 1710, and 1720. The correlators 1610, 1620, 1710, and 1720 may have the same structure as the correlator 961 of FIG. 9.

The cell searcher 1000 of FIG. 10 may be different from the cell searchers 400, 500, and 800 that have been described above in terms of the structure of the PN signal selector 1300. The PN signal selector 1300 may include a plurality of shift registers 1310, 1320, 1330, 1340, 1350, and 1360, multiplexers 1311, 1321, 1331, 1341, 1351, and 1361, and selectors 1312, 1322, 1332, and 1342.

Codes generated by the UMTS code generator 1100 may be input into the shift registers 1310, 1320, 1330, and 1340 in parallel. In FIG. 10, 32 codes may be input into the four 8-bit shift registers 1310, 1320, 1330, and 1340 in parallel. The shift registers 1350 and 1360 are connected in series and sequentially receive codes generated by the CDMA 2000 code generator 1200 and store the received codes.

The multiplexers 1311, 1321, 1331, 1341, 1351, and 1361 output codes received from their respective shift registers 1310, 1320, 1330, 1340, 1350, and 1360. These codes may be output in series in synchronization with a clock signal. The clock signal may be 8 times faster than the operation clock signal of a chip. The selectors 1312, 1322, 1332, and 1342 may selectively output the codes generated by the UMTS code generator 1100 or the codes generated by the CDMA 2000 code generator 1200 depending on the logic state of a mode selection signal MODE_SEL.

According to the example embodiments of the present invention, in a dual mode modem capable of supporting two different communication modes, e.g., a UMTS mode and a CDMA 2000 mode, a single cell searcher can serve as both a third-step searcher in the UMTS mode and a CDMA cell searcher in the CDMA mode. For example, the third-step searcher is capable of searching 32 PN codes, i.e., four groups of codes, at the same time in a UMTS mode in response to the mode selection signal MODE_SEL. The cell searcher is also capable of searching for a CDMA code in CDMA mode. Therefore, the cell searcher can carry out different cell searching processes for two different communication modes.

As described above, the integrated cell searchers according to the example embodiments of the present invention exhibit overall a reduced physical size and so contribute to a reduced size of a dual mode modem of which they form a part, respectively, and exhibit reduced cell searching time due to being capable of carrying out cell searching processes for different communication modes.

While the example embodiments of the present invention has been particularly shown and described with reference to example embodiments thereof, it will be understood by those of ordinary skill in the art that various changes in form and details may be made therein without departing from the spirit and scope of the present invention as defined by the following claims.

What is claimed is:

1. An integrated cell searcher comprising:
a first code generator which generates first codes for cell searching in a non-synchronous mode;
a second code generator which generates second codes for cell searching in a synchronous mode;
a signal selector which receives the first codes and the second codes, and selectively outputs either of the first codes or second codes, in response to a mode selection signal; and
a plurality of correlators which receive and correlate a code from a base station and the selected codes, respectively.

2. The integrated cell searcher of claim 1, wherein the first codes, second codes and code from the base station are pseudonoise (PN) codes.

3. The integrated cell searcher of claim 1, wherein each of the plurality of correlators further comprises:
a despreader which despreads the code received from a base station and the codes output from the signal selector and outputs a despreading result;
a synchronization accumulative register which receives signals from the despreader, accumulates the received signals in synchronization with a clock signal, and stores an accumulation result;
an energy converter which converts a signal output from the synchronization accumulative register into an energy signal; and
a non-synchronization accumulative register which accumulates signals output from the energy converter and stores an accumulation result.

4. The integrated cell searcher of claim 1 further comprising:
a peak detector which receives correlation results from the correlators and identifies which among the selected codes yielded the best correlation.

5. An integrated cell searcher comprising:
a first code generator which generates first codes for cell searching in a first communication mode;
a second code generator which generates second codes for cell searching in a second communication mode;
a signal selector which receives, buffers, and selectively outputs the first codes and the second codes in response to a mode selection signal; and
a plurality of correlators which receive and correlate a code from a base station and the selected codes, respectively.

6. The integrated cell searcher of claim 5, wherein the first codes, second codes and code from the base station are pseudonoise (PN) codes.

7. The integrated cell searcher of claim 5, wherein the first mode corresponds to UTMS and the second mode corresponds to CDMA.

8. The integrated cell searcher of claim 5 wherein the plurality of correlators are caused to perform cell searching for the first communication mode or the second communication mode depending on whether the first codes or the second codes are selected by the signal selector.

9. The integrated cell searcher of claim 5, wherein the signal selector comprises:
a plurality of N-bit registers which serially receive and buffer the first codes;
a plurality of multiplexers which selectively output ones from among the first codes stored in the N-bit registers in synchronization with a clock signal; and
a selector which receives and selectively outputs either the selected ones of the first codes or the second codes, in response to a mode selection signal.

10. The integrated cell searcher of claim 8, wherein the clock signal has an N times higher frequency than a nominal clock signal of a multi-mode modem with which the integrated cell can be used.

11. The integrated cell searcher of claim 5, wherein each of the correlators comprises:
a despreader which despreads the code received from the base station and the selected codes from the signal selector and outputs a despreading result;
a synchronization accumulative register which receives signals from the despreader, accumulates the received signals in synchronization with a clock signal, and stores an accumulation result;
an energy converter which converts a signal output from the synchronization accumulative register into an energy signal; and
a non-synchronization accumulative register which accumulates signals output from the energy converter and stores an accumulation result.

12. The integrated cell searcher of claim 5 further comprising:
a peak detector which receives signals from the correlators and identifies which among the selected codes yielded the best correlation.

13. An integrated cell searcher of a dual mode modem, which supports first and second communication modes, the integrated cell searcher comprising:
first code means for generating first PN codes used in a first communication mode cell searching process;
second code means for generating second PN codes, used in a second communication mode cell searching process;
PN selection means for selectively outputting the first PN codes or the second codes in response to a mode selection signal; and
correlator means for correlating a code signal received from a base station with the selected PN codes, respectively.

14. A method for cell searching using a dual mode modem comprising:
generating first codes for cell searching in a first mode;
generating second codes for cell searching in a second mode;
selecting between either the first codes or the second codes in response to a mode selection signal; and
correlating a code from a base station and the selected codes.

15. The method for cell searching using dual mode modem according to claim 14, wherein the correlating step further comprises:
despreading the codes received from a base station and the selected codes and outputting a despreading result;
accumulating multiple instances of the despreading result in synchronization with a clock signal and storing an accumulation result;
converting the accumulation result into an energy signal;
accumulating multiple instances of the energy signal; and
storing an accumulation result.

16. The method for cell searching according to claim 14 further comprising:
operating upon the correlation results to identify which among the selected codes yielded a best correlation; and
outputting a detection result.

17. The method for cell searching according to claim 14 wherein the first codes, second codes, and code from the base station are psuedonoise (PN) codes.

18. A method for cell searching according to claim 14 wherein the first mode is a non-synchronous mode and the second mode is a synchronous mode.

19. A method for cell searching according to claim 14 wherein the first mode corresponds to UMTS and the second mode corresponds to CDMA.
